(19) United States
(12) Patent Application Publication
(10) Pub. No.: US 2025/0275651 A1
(43) Pub. Date: Sep. 4, 2025

(54) HOPPER FOR FOOD PRODUCTS AND MACHINE COMPRISING SAID HOPPER

(71) Applicant: DE' LONGHI APPLIANCES S.R.L. CON UNICO SOCIO, Treviso (IT)

(72) Inventors: Giovanni Rossetto, Treviso (IT); Roberto Sanson, Treviso (IT); Dario Miatello, Treviso (IT)

(73) Assignee: DE' LONGHI APPLIANCES S.R.L. CON UNICO SOCIO, Treviso (IT)

(21) Appl. No.: 18/858,594

(22) PCT Filed: Apr. 21, 2023
(86) PCT No.: PCT/IT2023/050109

§ 371 Date: Oct. 21, 2024

(30) Foreign Application Priority Data
Apr. 21, 2022 (IT) 102022000007871

(51) Int. Cl. A47J 42/50; A47J 31/42; A47J 47/06

(52) U.S. Cl. CPC A47J 42/50; A47J 31/42; A47J 47/06

(57) ABSTRACT

Hopper (10) for food products in the form of grains, beans, powder or suchlike, comprising a container (11) for the food products having an introduction aperture (13) and an exit aperture (12), attachment means (19) configured to selectively and removably attach the container (11) to a machine (200) for processing the food products, a pneumatic connection member (20) configured to allow the extraction of air from the container (11) and closing means (15, 17) configured to selectively and hermetically seal the container (11).

### FIELD OF THE INVENTION

The present invention concerns a hopper for containing and feeding food products, such as grains, beans, seeds, soluble and non-soluble powders or suchlike, and a machine for processing said food products comprising the hopper. The hopper and the machine of the present invention can find application, by way of example, in the field of domestic or professional electrical appliances for processing coffee beans, such as coffee grinders and/or machines for producing coffee beverages starting from coffee beans.

### BACKGROUND OF THE INVENTION

It is known that certain environmental conditions can cause, or accelerate, the degradation of some food products, for example, roasted coffee beans.

In fact, roasted coffee beans degrade rapidly if stored in contact with air, which triggers the oxidation of the fatty acids contained in the beans and the development of the rancid taste of oxidized coffee.

Other parameters that accelerate the degradation of roasted coffee beans are the temperature and humidity rate of the environment in which they are stored, as well as exposure to light. Therefore, in some cases, the coffee beans are stored in a refrigerator, or in other similar places.

Storage in a refrigerator, however, may not be sufficient if the beans are to be left unused for a long period of time.

Moreover, there is an ever increasing presence of so-called “coffee prosumers”, that is, those coffee consumers who are looking for a tasting experience that also includes the comparison between coffee obtained with beans of different origins, degrees of roasting, etc.

For such consumers, and others, there exists, on the one hand, the need to store even different types of coffee in conditions that prevent the degradation of the beans, even for prolonged periods of time, and, on the other hand, the need to produce coffee beverages with a type of bean that is different on each occasion, in a simple manner and limiting or eliminating coffee waste.

Solutions are known of machines for preparing beverages starting from coffee beans which comprise a fixed bean containing hopper, which communicates with an intermediate chamber disposed downstream of a grinding device by means of a door which can be closed or opened, allowing the beans to fall by gravity into the intermediate chamber. The containing hopper is connected to a pumping member configured to draw the air contained inside it.

This solution, although it does allow to slow down the oxidation of the coffee beans inside the containing hopper, does not allow the user to easily and frequently vary the type of coffee beans used between the preparation of one beverage and the next. Furthermore, this solution does not allow to preserve the aroma of the beans present in the intermediate chamber or in the grinding device itself, which can therefore degrade by remaining in contact with the ambient air.

Document ITUA20162864A1 describes an apparatus for storing and dispensing coffee beans comprising a storage hopper and a bean collection and processing device that is selectively placed in communication with the storage hopper via a dispensing device, which also acts substantially as a closure element, and a connecting member for connecting to means for creating a vacuum arranged at a bottom of the storage hopper.

WO2006/120560A1 describes a coffee dispenser comprising a storage container and a dispensing chamber arranged below the container and connected thereto through an opening associated with a sliding member. In such a solution, both the storage container and the dispensing chamber are connected to a circuit to create a vacuum. The solution described in WO2006/120560A1 does not allow the coffee dispenser to be separated from the circuit while keeping the container in the vacuum condition.

Document US2004/025703A1 describes a coffee brewing apparatus having a hopper of fixed and non-removable type connected to means for creating vacuum.

US2015/135966A1 describes a known beverage preparation machine without means for vacuum generation.

There is therefore the need to perfect a hopper for food products and a machine for grinding food products that contains it, which can overcome at least one of the disadvantages of the state of the art.

One purpose of the present invention is to provide a hopper for food products which allows both to eliminate, or at least reduce, the degradation of said products and also to be easily associated with a machine for processing said food products in a simple and removable manner.

Another purpose of the present invention is to provide a hopper for food products which allows to maintain the conditions for optimal preservation of said food products even when it is disconnected from the machine for processing said food products.

Another purpose of the invention is to provide a processing machine suitable to process only the required quantity of products on each occasion.

Another purpose of the invention is to provide a machine and a method for processing food products which allow to easily and frequently change the type of products to be processed, avoiding contamination with the previous one.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a hopper has been embodied for feeding food products in the form of beans, grains, seeds, powders or suchlike, comprising a container for such food products having an aperture for the introduction of the food products and an aperture for their exit.

The hopper comprises attachment means configured to allow to selectively and removably attach the container to a machine for processing the food products.

In accordance with one aspect of the present invention, the hopper also comprises closing means configured to selectively seal the container in a hermetic manner, and a pneumatic connection member configured to allow the extraction of air from the container.

When the hopper is installed on a machine, the pneumatic connection member can be advantageously connected to a suction member of such machine.

In accordance with another aspect of the present invention, the pneumatic connection member is associated with a suction aperture of the container and comprises a valve of the normally closed type.

Thanks to the presence of the valve, the hopper can be kept in a vacuum condition even when it is removed from the machine, so as to optimally preserve the food products present inside it.

In accordance with another aspect of the present invention, the valve is configured to alternatively assume a closing position, in which it hermetically closes the suction aperture, or an opening position, in which it allows the passage of air through the suction aperture, and it is held in the closing position by elastic return.

In particular, the valve can assume an opening position in cooperation with the suction member of the machine.

In accordance with another aspect of the present invention, the closing means comprise a first closing member to selectively seal the introduction aperture in a hermetic manner, and a second closing member to selectively seal the exit aperture in a hermetic manner.

In accordance with another aspect of the present invention, the second closing member comprises a closing wall, mobile in such a way as to be positioned overlapping with the exit aperture.

In accordance with one aspect of the present invention, the closing wall can be moved manually by a user.

In accordance with another aspect of the present invention, the closing member comprises a drive member to selectively move the closing wall and position it overlapping with the exit aperture.

In accordance with another aspect of the present invention, the hopper comprises feed means, at least partly disposed inside the container and configured to selectively feed a certain quantity of the food products toward the exit aperture.

In accordance with another aspect of the present invention, the feed means are configured to receive motion from mating drive means of the machine.

In accordance with another aspect of the invention, the suction aperture is arranged on a lateral wall of the container.

In accordance with another aspect of the invention, an upper aperture is created on the first closing member in which a mobile sealing member is inserted, configured to slide with respect to the upper aperture in a manner that is proportional to the vacuum generated, or present, inside the container. In this way a user can know the vacuum level present inside the container simply observing the position of the mobile sealing member with respect to the closing member.

The present invention also concerns a machine for processing food products which comprises a frame that defines a compartment for housing the hopper, a suction member and a grinding device having an entry aperture for the food products.

Holding means are disposed in the compartment, which are configured to cooperate with the attachment means of the hopper in order to allow to connect the latter to the compartment in a removable manner.

In accordance with another aspect of the present invention, the exit aperture is overlapping with the entry aperture when the hopper is housed in the compartment.

In accordance with another aspect of the present invention, the machine also comprises drive means configured to drive feed means of the hopper when it is connected to the first holding means.

In accordance with another aspect of the present invention, the machine also comprises means for detecting the presence of the hopper in the compartment. The machine also comprises means for detecting the closure of the exit aperture.

Moreover, the machine also comprises a control unit communicating with the first and second detection means and configured to control the operation of the suction member on the basis of at least one electrical signal transmitted by the first and second detection means.

In accordance with another aspect of the present invention, a method of operation of a machine according to the present invention for preserving food products in the form of grains or beans provides to:
dispose the hopper in the compartment and connect the attachment means to the holding means;
connect the pneumatic connection member to the suction member;
hermetically seal the container by means of the closing means;
activate the suction member in order to draw the air contained in the container.

In accordance with another aspect of the present invention, the method also provides to:
disconnect the pneumatic connection member from the suction member in such a way that the valve moves into a closed position to seal the suction aperture;
disconnect the hopper from the holding means in order to remove it from the compartment.

The hopper can therefore be advantageously disconnected from the machine and stored in a pantry or in a refrigerator, for example, allowing to preserve the food products present therein in an optimal manner, even for long periods of time, for example weeks or even months.

In accordance with one aspect of the present invention, before activating the suction member the method provides to:
verify that the hopper is connected to the holding means;
verify that the exit aperture is hermetically closed.

In accordance with another aspect of the present invention, before activating the suction member the method provides to verify that the pneumatic connection member is connected to the suction member.

In accordance with another aspect of the invention, the method provides adjusting the operation of the suction organ so as to reach certain different vacuum levels inside said container in relation to an indication of a machine downtime provided by a user via a user interface.

In accordance with a further aspect of the invention, the method provides monitoring the downtime of the machine and activating the suction organ in such a way as to define progressively higher vacuum levels in said container on the basis of the detected time value in order to increase the shelf life of the food products.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic representation of a hopper in accordance with some embodiments of the present invention, associated with a machine for processing food products in the form of grains, beans, powder or suchlike;

FIG. 2 is a section view of a hopper in accordance with a first embodiment of the present invention;

FIGS. 3 and 4 are enlargements of FIG. 2;

FIG. 5 is a three-dimensional view of the hopper of FIG. 1 in association with a machine in accordance with the present invention;

FIGS. 6, 7 and 9 are broken and schematic views of a hopper in accordance with a second embodiment of the present invention, in association with a machine for processing food products in the form of grains, beans or powder or suchlike;

FIGS. 8 and 10 are enlarged views of FIGS. 7 and 9, respectively;

FIG. 11 is a block diagram of a method according to the present invention.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

With reference to the attached drawings, a hopper 10 is described for containing and feeding food products, such as beans, grains, seeds, powders or suchlike, toward a processing device 202 of a machine 200 for processing the food products.

In the present description and in the attached claims, by the term “food products” we mean, beans and/or seeds and/or powders, for example, but not only, of the type suitable to prepare a beverage. In particular, the food products can be coffee beans or parts thereof, or coffee powder. However, other types of food substances are not excluded, such as for example seeds, cereals, barley, grains of salt or pepper, or suchlike.

Moreover, in the example given here, the processing device 202 is a grinding device and it is configured to receive the food products at entry and grind them so as to obtain a dose of coffee powder, in the event that the food products are in the form of beans or grains. However, in other embodiments the processing device 202 can be a chamber for containing the beans, or an infusion unit or a mixing unit, in the event that the processed food products are in powder form, or yet another type of device.

The machine 200 comprises a frame 201 to which the grinding device 202 is fixed, of a type known per se and which will not be described in detail, having an entry aperture 204 for the food products.

The frame 201 also defines a compartment 203 having first holding means 206 configured to allow to selectively and reversibly connect the hopper 10 to the machine 200, as will be described in detail below.

In some embodiments, the machine 200 can also comprise other components, which will not be described, for preparing a beverage by infusing the powder mixture prepared by the grinding device 202. In some embodiments, the grinding device 202 can be a mean configured to transform the food product contained in the hopper 10 into a beverage, for example in the event the food product is in the form of a powder, such as an infusion unit for example.

The hopper 10 is configured to contain the food products to be fed to the grinding device 202 and comprises a container 11 for the food products having an introduction aperture 13 and an exit aperture 12 for the food products. The hopper 10 also comprises closing means configured to allow to hermetically seal the introduction aperture 13 and the exit aperture 12.

The closing means comprise a first closing member 15 to selectively seal the introduction aperture 13 and a second closing member 17 to selectively seal the exit aperture 12.

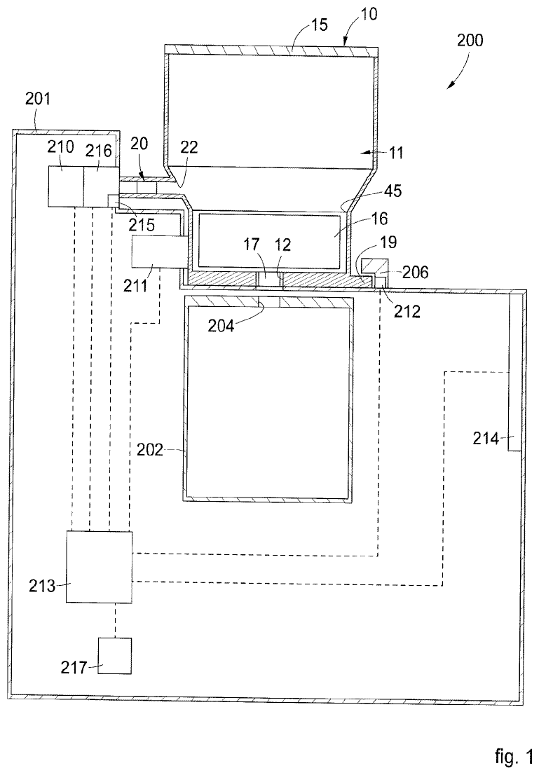

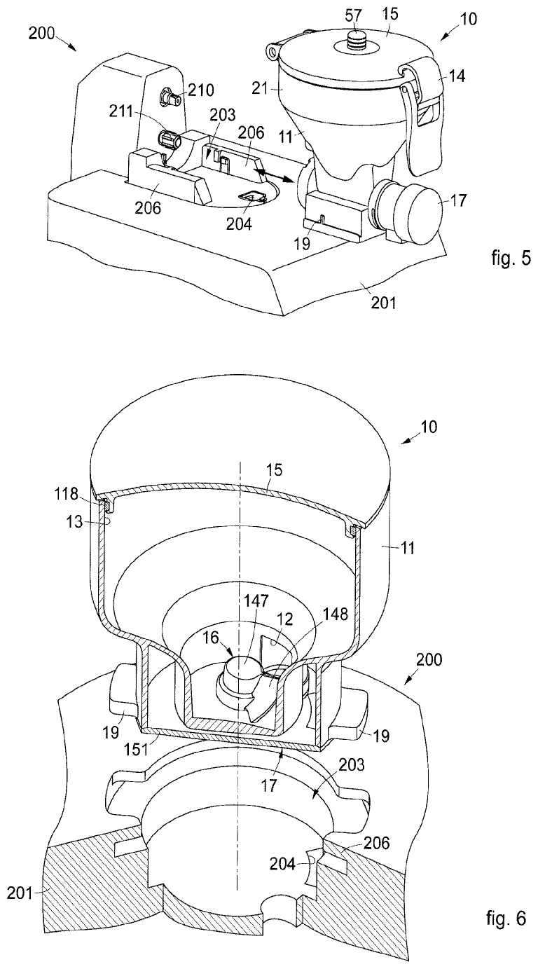

In the embodiment of FIGS. 1-5, the first closing member 15 comprises a lid pivoted to a wall 21 of the container 11, associated with a hook 14 suitable to press it against the perimeter of the introduction aperture 13. Moreover, preferably, a packing 18 is disposed between the pivoted lid and the perimeter of the introduction aperture 13 to guarantee the hermetic seal.

In the embodiment of FIGS. 6-10, the first closing member 15 comprises a lid connected to the container 11 by interference, and having a sealing packing 118 located in abutment against the perimeter of the introduction aperture 13.

In other embodiments, not shown in the attached drawings, the first closing member 15 can comprise a lid provided with first flexible-type sealing means configured to slide in contact with the internal surface of the walls 21 of the container 11 in order to close the latter with a hermetic seal with respect to any air coming from the outside of the introduction aperture 13.

By way of example, the sealing means comprise a flexible ring configured to come into contact with the internal surface of the walls 21 of the container 11. In these embodiments, the lid can be configured to rest on the surface defined by the food products present in the container 11, so as to limit the space not occupied by the food products.

The hopper 10 also comprises feed means 16, disposed at least partly inside the container 11 and selectively drivable to displace the food products from the lower part of the container 11 toward the exit aperture 12.

The hopper 10 of the present invention can be selectively connected to the machine 200, in a removable manner, by means of attachment means 19 configured to cooperate with the holding means 206 present in the compartment 203.

In accordance with one aspect of the present invention, the hopper 10 also comprises a pneumatic connection member 20 configured to allow the extraction of the air present inside the container 11 by means of a suction member 210.

Preferably, the pneumatic connection member 20 is of the normally closed type, that is, if not driven it prevents the passage of fluids from the container 11 to the outside, and vice versa.

In the embodiments that will be described below, the suction member 210 is external to the hopper 10, that is, it is not comprised therein, and it is disposed on board the machine 200.

In some embodiments, the suction member 210 can be fixed on the machine 200. In other embodiments, the suction member 210 can be mobile with respect to the machine 200, for example between an operating position and a non-operating position, or it can be extractable from the external body thereof.

In other embodiments, it is not excluded that the hopper 10 can have its own suction member, connected to the pneumatic connection member 20 or comprised therein.

Advantageously, the hopper 10 of the present invention allows both to extract air from the container 11 and create a vacuum inside it, and also to hermetically seal the container 11 by means of the closing members 15, 17 and the pneumatic connection member 20.

This allows to prevent the degradation of food products, and in particular of the coffee beans or powder, caused by the oxidation of the fatty acids, thus improving the preservation of the coffee aroma and the satisfaction of the end user.

The fact that the pneumatic connection member 20 is of the normally closed type allows to disconnect the hopper 10 from the machine 200 while maintaining the condition of vacuum inside the container 11.

This allows to store the hopper 10 even in a location distant from the machine 200, at the same time guaranteeing the perfect preservation of the quality of the food products. For example, the hopper 10 of the present invention can be disconnected from the machine 200 and placed in a refrigerator, or in another place suitable to preserve the aroma of the coffee, and it can be reconnected to the machine 200 only when necessary.

This allows to limit the exposure of the hopper 10, and therefore of the food products contained in the container 11, to the temperature variations which occur in the place where the machine 200 is disposed.

This allows a user to have a plurality of hoppers 10, each of which contains a different variety of coffee beans or powder, and to alternately connect them to the machine 200 so as to experiment with different types of coffee, always keeping the perfect preservation conditions of the coffee in each hopper 10.

With reference to the embodiment shown in FIGS. from 2 to 5, the container 11 is defined by a plurality of walls 21 and comprises at least one suction aperture 22 with which the pneumatic connection member 20 is associated.

With reference to the embodiment shown in FIGS. 1, 6, the container 11 is defined by a lateral wall and comprises at least one suction aperture 22 with which the pneumatic connection member 20 is associated.

The suction aperture 22 is preferably disposed on a lateral wall 21 of the container 11.

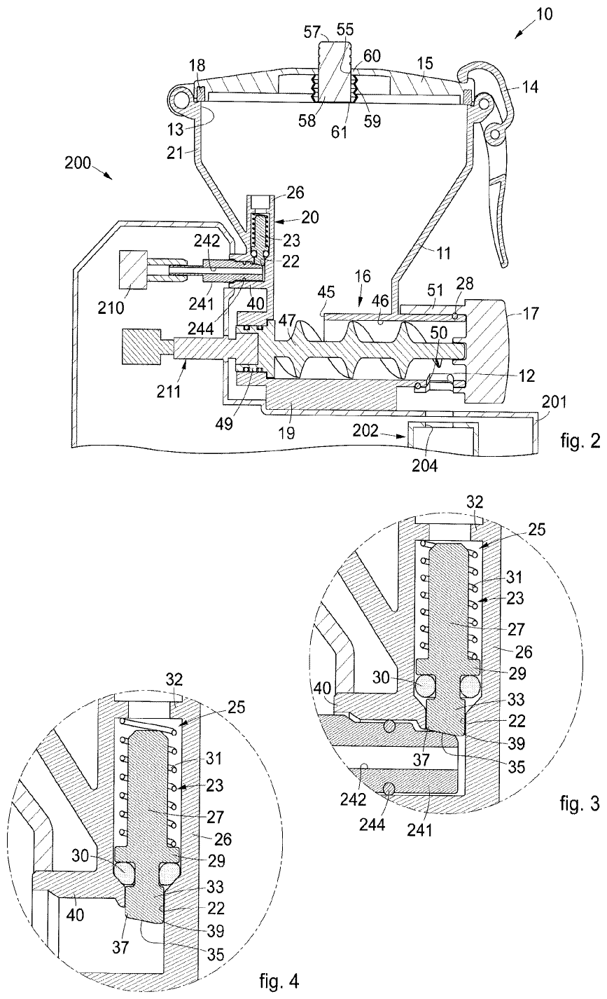

In this first embodiment of FIGS. 2-5, the pneumatic connection member 20 comprises a valve 23 of the normally closed type, configured to pass from a closed position, in which it hermetically seals the suction aperture 22, to an open position, in which it allows the passage of air through the suction aperture 22.

The valve 23 is held in the closed position by elastic means 25 configured to store energy when the valve is moved from the closed position to the open position.

Preferably, the valve 23 is inserted in a vertical duct 26 contained in the container 11 and which ends in correspondence with the suction aperture 22. The valve 23 comprises a central body 27 having a discoidal protuberance 29 projecting radially and interposed between its two ends. The discoidal protuberance 29 is configured to press a packing 30 associated with the central body 27 in correspondence with the perimeter of the suction aperture 22 when the valve 23 is in the closed position.

The elastic means 25 comprise a spring 31 coaxial to the central body 27 and having one end in contact with the discoidal protuberance 29 and another end in contact with an abutment portion 32 of the vertical duct 26.

Therefore, the spring 31 is confined between the discoidal protuberance 29 of the central body 27 and the abutment portion 32 of the vertical duct 26, whereby a movement of the central body 27 with respect to the vertical duct 26 triggers the compression of the spring 31 which tends to return, by elastic return, the discoidal protuberance 29 and the packing 30 against the perimeter of the suction aperture 22, and therefore the valve 23 in the closed position.

The valve 23 has one end 33 having an activation portion 35 protruding outside the suction aperture 22.

The activation portion 35 is configured to take the valve 23 from the closed position to the open position when it is connected to the suction member 210.

In this case, the activation portion 35 is in the form of an inclined plane having an initial end 37 disposed flush with the suction aperture 22 and a final end 39 protruding from the suction aperture 22 when the valve 23 is in the closed position.

The pneumatic connection device 20 also comprises a fixed external body 40, substantially cylindrical in shape, which develops from the walls 21 of the container 11 in correspondence with the suction aperture 22.

The fixed external body 40 is configured to accommodate inside it a connection body 241 of the suction member 210, which in turn is configured and conformed in such a way as to be able to act on the activation portion 35.

Preferably, a packing 244 is disposed between the fixed external body 40 and the connection body 241.

In particular, when the connection body 241 is completely inserted in the fixed external body 40, it abuts against the activation portion 35 and triggers the translation of the central body 27 inside the vertical duct 26, lifting the discoidal portion 29 and the packing 30 from the perimeter of the suction aperture 22, thus taking the valve 23 from the closed position to the open position.

Inside the connection body 241 there is created a suction duct 242 made through and such that, when the connection body 241 is inserted in the fixed external body 40, a fluidic connection is established which puts the inside of the container 11 in communication with the suction aperture 22 and with the suction duct 242.

Preferably, the attachment means 19 and the holding means 206 of the machine 200 are positioned in such a way that the connection body 241 is inserted in the fixed external body 40 the moment the hopper 10 is connected to the machine 200.

In this first embodiment, the feed means 16 are disposed partly inside the container 11 and are configured to be driven by mating drive means 211 of the machine 200. However, in other embodiments not shown, the drive means 211 can be provided on board the hopper 10.

Moreover, in this first embodiment, referring to FIG. 2, feed means 16 are disposed in correspondence with a lower aperture 45 of the container 11 and comprise a feed channel 46.

Inside the feed channel 46 there is disposed an auger 47, configured to selectively feed the food products coming from the lower aperture 45 toward the exit aperture 12 and therefore toward the grinding device 202.

At one end of the auger 47, opposite the exit aperture 12, there are disposed connection elements 49 configured to cooperate with the drive means 211, receive motion from the latter and transmit it to the auger 47.

In accordance with some variants, the connection elements 49 comprise one or more transmission gears, not shown in the drawings and suitable to couple mechanically with a drive shaft of the drive means 211.

In accordance with some variants, the connection elements 49 comprise one or more magnetic dragging elements, not shown in the drawings and suitable to be magnetically attracted by mating magnetic dragging elements of the drive means 211.

The feed channel 46 comprises an aperture or a hole 50 which defines the exit aperture 12, which faces toward the entry aperture 204 of the grinding device 202 when the hopper is connected to the machine 200.

We must clarify that between the exit aperture 12 of the hopper 10 and the entry aperture 204 of the grinding device 200 there may also be intermediate members such as, for example, a conveyor or collection chamber (not shown).

In this first embodiment, referring to FIG. 2, the second closing member 17 is disposed in correspondence with the hole 50 of the feed channel 46 and comprises a closing wall 51 rotatable so as to pass from an opening position to a closing position in which it closes the hole 50 hermetically.

Preferably, a packing 28 is associated with the second closing member 17. The packing 28 can be, for example, an O-ring, which can be disposed inclined in order to guarantee a correct seal.

The second closing member 17 can be positioned manually between the opening and closing positions by a user.

Alternatively, or in addition, the second closing member 17 can be positioned between said positions automatically, by a drive member (not shown).

The possibility of selectively closing the hole 50, and therefore the exit aperture of the food products 12, advantageously allows to be able to replace the hopper 10 easily, without causing unwanted drops of food products and keeping the container 11 sealed, preventing air leakages inside the latter.

In a second embodiment, shown schematically in FIGS. 6-10, the hopper 10 is configured to be fixed to the machine 200 by means of an attachment mechanism of the bayonet type, known per se and which will not be described in detail.

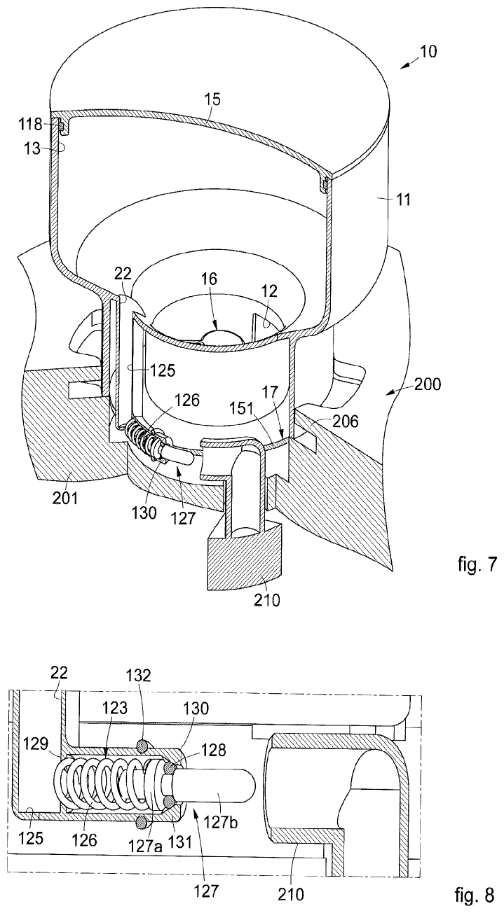

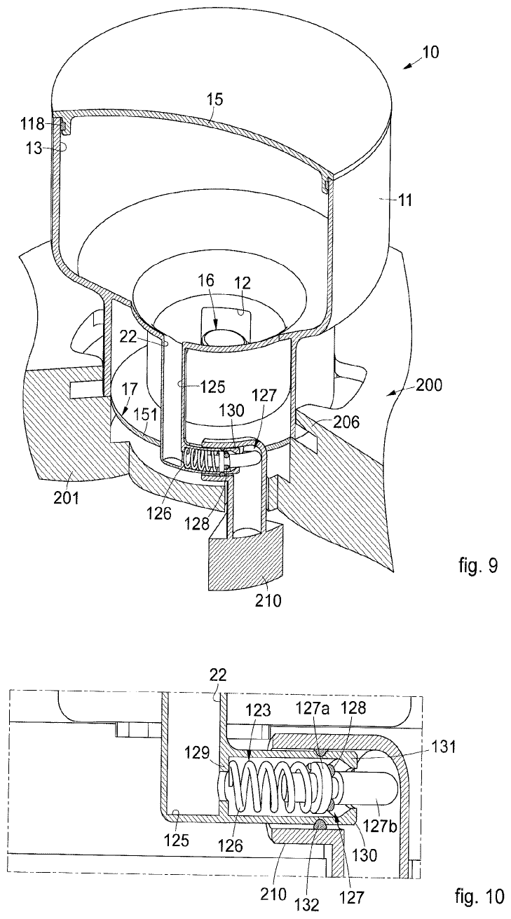

In this case, the hopper 10 can be selectively taken by a user into one of the following operating positions:
an unloading position in which it is attached to the machine 200 and the exit aperture 12 of the food products is open to allow the unloading of the food products into the grinding device 202 (FIG. 7);
a suction position in which the pneumatic connection member 20 is connected to the suction member 210 and the exit aperture 12 is hermetically closed (FIG. 9);
a neutral position in which the exit aperture 12 is hermetically closed, the pneumatic connection member 20 is disconnected from the suction member 210 and the hopper 10 can be disconnected from the machine 200.

In this case, the compartment 203 of the machine 200 comprises a substantially cylindrical cavity and the holding means 206 define a preestablished path for the second attachment means 19 of the hopper 10. In particular, the path comprises a rectilinear segment to allow the insertion of the hopper 10 in the compartment 203 up to the neutral position. Moreover, the path also comprises two segments in the shape of an arc of a circumference and which develop from the terminal part of the rectilinear segment in opposite directions to each other.

A rotation of the hopper 10 from the neutral position in a first direction of rotation takes the hopper 10 into the unloading position. Furthermore, a rotation of the hopper 10 from the neutral position in a second direction of rotation, opposite to the first direction of rotation, takes the hopper 10 into the suction position.

In this case, the second closing member 17 comprises a closing wall (not shown) suitable to be attached to the compartment 203 of the machine 200 when the hopper 10 is in the neutral position and having an unloading aperture (not shown).

When the user takes the hopper 10 from the neutral position to the unloading position, he/she also causes a rotation of the container 11 with respect to the closing wall, taking the exit aperture 12 into alignment with the unloading aperture of the closing wall. Moreover, when the user takes the hopper 10 from the unloading position to the neutral position, he/she also causes a rotation of the container 11 with respect to the closing wall, moving the exit aperture 12 away from the unloading aperture so that the exit aperture is closed by the closing wall.

Lastly, when the user takes the hopper 10 from the neutral position to the suction position, he/she also causes a rotation of the container 11 with respect to the closing wall, keeping the exit aperture 12 closed by the latter.

In this second embodiment, the feed means 16 can comprise a metering device, of any known type whatsoever, for example comprising a rotating element 147 provided with one or more radial blades 148 (FIG. 6) which is connected to an electric motor, such that with each rotation, even partial, of the rotating element 147, a certain quantity of food products is taken in correspondence with the exit aperture 12.

Preferably, the rotating element 147 is provided with a single radial blade 148.

Furthermore, in this second embodiment, the pneumatic connection member 20 comprises a valve 123 of the normally closed type inserted in a duct 125 which develops from the suction aperture 122 toward the outside of the container 11.

According to some embodiments, the duct 125 can be L-shaped and the valve 123 can be disposed in the horizontal segment, although other possible solutions are not excluded.

The valve 123 comprises a spring 126 which presses on an abutment portion 129 of the duct 125 and on a body 127 which comprises a shutter portion 127a disposed in the duct 125, the shutter portion 127a obstructing the duct 125 in correspondence with a connection end 130 thereof, and an actuation portion 127b disposed protruding from the connection end 130. In particular, the connection end 130 is configured to be attached to the suction member 210 of the machine 200 when the hopper 10 is taken from the neutral position to the suction position.

The spring 126, in a resting position, thrusts the body 127 in such a way that the shutter portion 127a abuts against a shoulder 131 of the connection end 130, while the actuation portion 127b is disposed protruding beyond the connection end 130.

When the connection end 130 is connected to the suction member 210, the body 127 is thrust inside the duct 125, compressing the spring 126 and moving the shutter portion 127a away from the shoulder 131, thus opening a passage for air which fluidically connects the inside of the container 11 with the suction member 210 (FIG. 10).

When the connection end 130 is disconnected from the suction member 210, the spring 126 returns the shutter portion 127a of the body 127 in abutment against the shoulder 131, in the position in which it obstructs the duct 125 so that the previously obtained vacuum level can be kept inside the hopper 10.

Preferably, at least one packing 128 is disposed between the body 127 and the internal walls of the duct 125, in particular between the shutter portion 127a and the shoulder 131.

Another packing 132 can also be provided on the outside of the duct 125, configured to cooperate with the suction member 210.

Also in this second embodiment, the conformations of the valve 123 and of the closing members 15, 17 allow both to hermetically seal the container 11 during the suction by the suction member 210, and also to keep the container 11 sealed when the suction operation is completed. In addition, the conformations of the valve 123 and of the closing members 15, 17 also allow to disconnect the hopper 10 from the machine 200, keeping the container 11 hermetically closed in order to preserve the vacuum condition generated by the suction member 210.

We must clarify that in other embodiments the hopper 10 can be connected to the machine 200 by means of any other known attachment mean, even different from the two examples described, which allows their temporary and reversible coupling.

Moreover, in other embodiments the conformation of the closing member 17 can be different from what has been described, it being understood that its function is to allow the hermetic closure of the exit aperture 12 of the hopper 10.

In some embodiments, which can be combined with those previously described, an upper aperture 55 can be created on the first closing member 15 in which a mobile sealing member 57 is inserted, configured to slide with respect to the upper aperture 55 in a manner that is proportional to the vacuum generated in, or present inside the container 11.

In the example given here, the sealing member 57 comprises a pin 58 inserted in the upper aperture 55 and a sealing element 59 having one end 60 connected to the first closing member 15 and another end 61 connected to the pin 57. The sealing element 59 is conformed as a bellows and in a resting condition, that is, in which atmospheric pressure is present inside the container 11, it positions the pin 58 in a neutral position in which it is outside of the upper aperture 55 for half of its extension and inside the container 11 for the other half of its extension.

On the other hand, if a vacuum is created inside the container 11, the pin 58 moves toward the inside of the container 11 by an amount proportional to the vacuum created. Preferably, the sealing element 59 is designed to be completely extended when the absolute pressure inside the container 11 substantially corresponds to the minimum pressure achievable, so as to position the upper part of the pin 58 flush with the first closing member 15. This allows the user to always know what the vacuum level present inside the container 11 is, even when the hopper 10 is disconnected from the machine 200.

The present invention also concerns the machine 200 for processing food products in the form of seeds, grains or beans, or powder, to which a hopper 10 in accordance with the present invention can be selectively connected.

The machine 200 also comprises first means 212 for detecting the presence of the hopper 10 in the compartment 203, which are communicating with a control unit 213, for example of the programmable type.

In the case of a hopper 10 according to the first embodiment, the first detection means 212 can be associated, for example, with the first holding means 206 of the machine 200 and are configured to transmit an electrical signal to the control unit 213 which signals whether or not the hopper 10 is connected to the machine 200.

In the case of a hopper 10 in accordance with the second embodiment, the first detection means 212 can be associated, for example, with the first holding means 206 of the machine 200 and be configured to transmit an electrical signal to the control unit 213 which signals both whether or not the hopper 10 is connected to the machine 200 and also in which operating position the hopper 10 is.

The machine 200 also comprises second means 215 for detecting the position of the second closing member 17, which are also communicating with the control unit 213 and are configured to transmit a signal to it which signals whether the exit aperture 12 is hermetically closed.

The control unit 213 is also configured to detect whether the hopper 10 is in a condition whereby it is possible to draw the air from the container 11 and generate a vacuum inside it. For example, such condition can be satisfied when the exit aperture 12 is hermetically closed by the second closing member 17 and when the pneumatic connection member 20 is connected to the suction member 210. This detection can occur through communication between the control unit 213 and the first 212 and second 215 detection means.

Moreover, the control unit 213 is also configured to activate the suction member 210 when it recognizes that the hopper 10 is in the condition whereby it is possible to generate a vacuum inside the container 11.

The activation of the suction member 210 can occur automatically, for example after a certain downtime of the machine 200. Alternatively, the activation of the suction member 210 can occur manually by a user by means of a user interface 214 connected to the control unit 213.

In addition, in some embodiments, the user can interact with the user interface 214 to control the operation of the suction member 210 so as to modulate the vacuum level that it generates inside the container 11.

For example, the user interface 214 can comprise a key which, when pressed by the user, activates the suction member 210 for the entire time it remains pressed and deactivates the suction member 210 when the user stops pressing it, or it can comprise a touch-sensitive screen or special buttons by means of which the user can define and/or select a desired vacuum level.

The machine 200 also comprises a pressure transducer 216 configured to detect the absolute pressure inside the container 11 and to transmit a pressure electrical signal proportional to the absolute pressure to the control unit 213. This allows to adjust the operation of the suction member 210.

For example, the operation of the suction member 210 can be adjusted so as to reach certain different vacuum levels inside the container 11, according to requirements.

By way of example, a first vacuum level can be associated with a relatively short downtime of the machine 200, for example of a few hours, a second vacuum level can be associated with a medium downtime of the machine 200, for example of a few days, and a third vacuum level can be associated with a relatively long downtime of the machine 200, for example of at least one week.

Furthermore, in these cases, the user can select the desired vacuum level by means of the user interface 214, according to the downtime of the machine 200.

In addition, the control unit 213 can process the pressure electrical signal transmitted by the pressure transducer 216 and it can command the user interface 214 to display on it an indication relating to the preservation duration of the food products correlated to the vacuum level inside the container 11 or possibly estimated on the basis of the vacuum level selected.

Optionally, the control unit 213 can also display on the user interface 214 an indication correlated to the pressure value measured by the pressure transducer 216. Alternatively, or in addition, the machine 200 can also comprise a pressure gauge connected to the container 11 and exposed to the user's view.

According to possible variants, it can also be provided that the control unit 213 can autonomously command the closure of one or both of the closing members 15, 17 after a certain downtime interval of the machine 200, and subsequently activate the suction member 210. For example, in the embodiments which provide it, the control unit 213 can also be configured to activate the drive member (not shown) associated with the closing member 17 in order to hermetically close the exit aperture 12.

In these cases, the control unit 213 can also comprise a unit 217 for detecting downtime, configured to detect and/or control how much time the machine 200 remains unused since it was last used. In these cases, the downtime detection unit 217 transmits a signal correlated to the downtime of the machine 200 to the control unit 213. If the downtime exceeds a predetermined downtime value, the control unit 213 can automatically activate the suction member 210 to withdraw the air from inside the container 11 in order to allow a better preservation of the food products.

Optionally, the vacuum level generated automatically by the suction member 210 can vary as a function of the downtime of the machine 200. In particular, it can be provided that the greater the downtime of the machine 200, detected by the downtime detection unit 217, the greater the vacuum level generated inside the container 11 by the suction member 210 automatically activated by the control unit 213.

For example, it can be provided that when a first predetermined time value is detected, the control unit 213 activates the suction member 210 to define a first vacuum level in the container 11, while when a second predetermined time value is detected the control unit 213 activates the suction member 210 to define a second vacuum level, greater than the first, in order to increase the preservation duration of the food products.

In addition, the machine 200 also comprises the drive means 211 to drive the feed means 16 of the hopper 10, which are commanded by the control unit 213 and can comprise any known mean for transmitting their movement to the feed means 16 of the hopper 10.

Purely by way of example, the drive means 211 comprise an electric motor (not shown) which moves a drive shaft mechanically or magnetically connected to the feed means 16 of the hopper 10.

According to other embodiments, not shown, the machine 200 can comprise weighing means, such as load cells for example, associated with the compartment 203 or with the grinding device 202, able to weigh the food products released by the hopper 10 or accumulated in the grinding device 202, and the control unit 213 can command the operation of the feed means 16 as a function of the data detected by the weighing means.

The use of the hopper 10 of the present invention in association with the machine 200 described heretofore, which corresponds to the method of the present invention, comprises the following steps.

The user positions the hopper 10 in correspondence with the compartment 203 to allow the attachment between the attachment means 19 and the holding means 206.

The introduction aperture 13 for the insertion of the food products is hermetically closed by means of the first closing member 15. We must clarify that this closing step by means of the first closing member 15 can also be performed when the hopper 10 is not connected to the machine 200.

The second closing member 17 can be moved to open the exit aperture 12 in order to allow the food products contained in the container 11 to be unloaded into the grinding device 202.

Then, in response to a request for a dose of coffee, the control unit 213 commands the drive means 211 to transmit motion to the feed means 16, which displace a certain quantity of food products toward the exit aperture 12.

When the dose of coffee has been transferred from the container 11 to the grinding device 202, the exit aperture 12 can be closed by means of the second closing member 17.

At this point it is possible to draw the air from inside the container 11 in order to improve the preservation conditions of the food products and prevent their degradation.

The request for air suction inside the container 11 can be performed manually by a user, or it can occur automatically following a certain period of time in which the machine 200 has not been used.

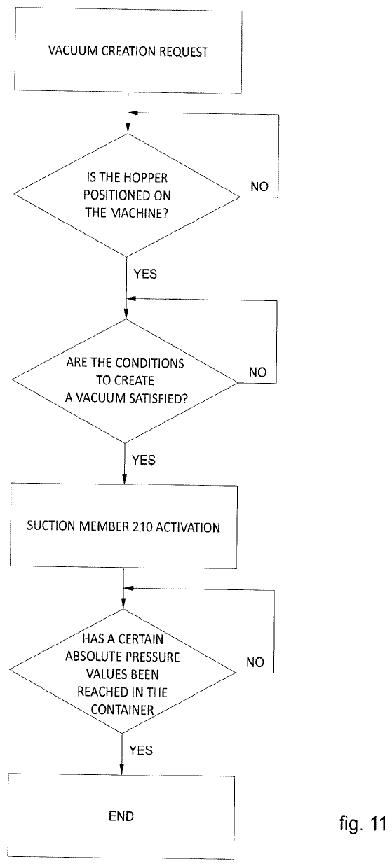

In response to a request for air suction, (FIG. 11) the control unit 213 performs a first step of verifying the presence of the hopper 10 on the machine 200.

This operation can be performed, for example, by means of the first detection means 212.

If the presence of the hopper on the machine 200 is verified, the control unit 213 performs a second verification step to determine whether the hopper 10 is in a condition in which the air present in the container 11 can be drawn.

This second verification step provides at least to determine that the exit aperture 12 is hermetically closed and that the pneumatic connection member 20 is connected to the suction member 210.

Subsequently, the control unit 213 performs a suction step, in which it activates the suction member 210 to withdraw the air from the hermetically sealed container 11.

During the suction step, a step of detecting the absolute pressure inside the container 11 is performed, by means of the pressure transducer 216.

When a certain absolute pressure value is reached inside the container 11, preferably comprised between 0 atmospheres and 1 atmosphere, the control unit 213 deactivates the suction member 210.

At this point, the container 11 is hermetically closed and substantially without air inside it, so that the food products it contains are preserved avoiding their degradation caused by the oxidation of fatty acids.

The user can then disconnect the hopper 10 from the machine 200 and keep the container 11 hermetically sealed thanks to the closing members 15, 17 and to the pneumatic connection member 20.

In particular, when a user disconnects the pneumatic connection member 20 from the suction member 210, the valve 23 moves to a closed position in order to seal the suction aperture 22 hermetically and allow to disconnect the hopper 10 from the holding means 206 in order to remove it from the compartment 203 maintaining the vacuum inside it.

In fact, we must clarify that the pneumatic connection member 20 and the closing means 15, 17 allow to maintain inside the container 11 the level of absolute pressure (or vacuum) reached thanks to the action of the suction member 210, even after the 10 hopper has been removed from the 200 machine.

Optionally, the disconnection from the suction member 210 and from the holding means 206 can be simultaneous. Alternatively, the disconnection from the suction member 210 and the disconnection from the holding means 206 occur in two different moments.

This allows to dispose the hopper 10 in a location distant from the machine 200 while maintaining the food products in perfect preservation conditions, and possibly to use the machine 200 in association with a second hopper containing a different type of food products, for example a different type of coffee.

It is clear that modifications and/or additions of parts may be made to the hopper 10, to the machine 200 and to the method as described heretofore, without departing from the field and scope of the present invention, as defined by the claims.

It is also clear that, although the present invention has been described with reference to some specific examples, a person of skill in the art will be able to achieve other equivalent forms of hopper, machines and methods for feeding and preserving food products, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. A hopper (10) for food products, the hopper comprising: a container (11) having an introduction aperture (13) and an exit aperture (12) for said food products, and attachment means (19) configured to selectively and removably attach said container (11) to a machine (200), wherein said hopper comprises a pneumatic connection member (20) which can be selectively opened or closed and is configured to allow the extraction of air from said container (11), which is selectively and hermetically sealed by closing means (15, 17), wherein said connection member (20) is associated with a suction aperture (22) of said container (11) and comprises a valve (23, 123) of the normally closed type.

2. The hopper (10) as in claim 1, wherein said valve (23, 123) is configured to alternatively assume a position in which it hermetically closes said aperture (22), or a position in which it allows the passage of air through said suction aperture (22) and is held in said closing position by elastic return.

3. The hopper (10) as in claim 1, wherein said closing means comprise a first closing member (15) to selectively seal said introduction aperture (13) in a hermetic manner, and a second closing member (17) to selectively seal said exit aperture (12) in a hermetic manner.

4. The hopper (10) as in claim 3, wherein said second closing member (17) comprises a closing wall (51, 151) which can be manually maneuvered by a user in order to be positioned overlapping with said exit aperture (12).

5. The hopper (10) as in claim 3, wherein said closing member (17) comprises a drive member to selectively move said closing wall (51, 151).

6. The hopper (10) as in claim 1, wherein said suction aperture (22) is disposed on a lateral wall of said container (11).

7. The hopper (10) as in claim 1, wherein said hopper comprises feed means (16) at least partly disposed inside said container (11) and configured to selectively feed a certain quantity of said food products toward said aperture (12), and wherein said feed means (16) are configured to receive motion from mating drive means (211) of said machine (200).

8. The hopper (10) as in claim 1, wherein an upper aperture (55) is created on the first closing member (15) in which a mobile sealing member (57) is inserted, configured to slide with respect to the upper aperture (55) in a manner that is proportional to the vacuum generated in, or present inside said container (11).

9. A machine (200) for processing food products, wherein said machine comprises a compartment (203) for housing a hopper (10) as in claim 1, holding means (206) configured to cooperate with said attachment means (19) to selectively and removably connect said hopper (10) to said machine (200), a suction member (210) configured to be connected to said pneumatic connection member (20) and a processing device (202) having an entry aperture (204) for said food products.

10. The machine (200) as in claim 9, wherein said exit aperture (12) is communicating with said entry aperture (204) when said hopper (10) is connected to said first holding means (206).

11. The machine (200) as in claim 9, and in which said hopper (10) comprises feed means (16) at least partly disposed in said container (11) and configured to selectively feed said food products toward said exit aperture (12), wherein said machine comprises drive means (211) configured to drive said feed means (16) when said hopper (10) is disposed in said compartment (203).

12. The machine (200) as in claim 9, wherein said machine comprises means (212) for detecting the presence of said hopper (10) in said compartment (203) and means (215) for detecting the closure of said exit aperture (12) and a control unit (213) communicating with said detection means (212, 215) and configured to control the operation of said suction member (210) on the basis of at least one electrical signal transmitted by said detection means (212, 215).

13. The machine (200) as in claim 9, wherein said machine comprises a user interface (214) connected to said control unit (213) and configured to allow the user to select a predetermined vacuum level to be generated inside said container (11) by means of said suction member (210).

14. The machine (200) as in claim 13, wherein said machine also comprises a pressure transducer (216) communicating with said container (11) and connected to said control unit (213) in order to transmit a pressure electrical signal to it correlated to the pressure detected inside said container (11), and in that and wherein said control unit (213) is also configured to process said pressure electrical signal and to command said user interface (214) and display thereon an indication of the preservation duration of said food products inside said container (11).

15. The machine of operation of a machine (200) as in claim 9, wherein for preserving food products in a hopper (10) said machine provides to:
connect said hopper (10) by coupling said attachment means (19) to said holding means (206);
connect said pneumatic connection member (20) to said suction member (210);
hermetically seal said container (11) by means of said closing means (15, 17);
activate said suction member (210) to draw the air contained in said container (11) in order to generate a vacuum level inside said container (11).

16. The machine as in claim 15, wherein said pneumatic connection member (20) is associated with a suction aperture (22) of said container (11) and comprises a valve (23, 123) of the normally closed type, wherein said machine provides to disconnect:
said pneumatic connection member (20) from said suction member (210) in such a way that said valve (23) moves into a closed position to seal said suction aperture (22);
said hopper (10) from said holding means (206) maintaining said vacuum level generated inside said container (11).

17. The machine as in claim 15, wherein before activating said suction member (210) said machine provides to verify that said hopper (10) is connected to said holding means (206) and to verify that said exit aperture (12) is hermetically closed by said closing means (17).

18. The machine as in claim 15, wherein before activating said suction member (210) said machine provides to verify that said pneumatic connection member (20) is connected to said suction member (210).

19. The machine as in claim 15, wherein said machine provides to regulate the operation of said suction member (210) so as to reach certain different vacuum levels inside the container (11) in relation to an indication of a machine downtime (200) provided by a user via a user interface (214).

20. The machine as in claim 15, wherein said machine provides to monitor the downtime of said machine (200) and to activate said suction member (210) so as to define progressively greater vacuum levels in said container (11) based on the time value detected in order to increase the shelf life of the food products.
